(19) United States
(12) Patent Application Publication
(10) Pub. No.: US 2007/0052982 A1
(43) Pub. Date: Mar. 8, 2007

(54) Color image forming apparatus and image forming method

(75) Inventor: Tetsuya Sadowara, Mishima-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/219,748

(22) Filed: Sep. 7, 2005

(51) Int. Cl. G06K 15/22

(52) U.S. Cl. 358/1.4; 358/1.16

(57) ABSTRACT

If a CPU is informed that “1200×1200 dpi” is selected from an input unit, the CPU switches a normal 8-bit RIP process with 600×600 dpi to a 1-bit RIP process with 1200×1200 dpi. Image data, which has become 1-bit data with 1200 dpi, is stored in a page memory. A pixel packing process unit executes (2×2) packing when the image data stored in the page memory is to be output from the page memory. The packed Y color image data is restored, without delay, to a normal pixel unit in a pixel division unit. The packed M color image data is restored, with a delay in a delay memory, to a normal pixel unit in the pixel division unit. The packed C color image data is restored, with a delay in the delay memory, to a normal pixel unit in the pixel division unit. The packed K color image data is restored, with a delay in the delay memory, to a normal pixel unit in the pixel division unit.

### BACKGROUND OF THE INVENTION

1. Field of the Invention

The present invention relates to a color image forming apparatus with a function of delaying image data outputs on a color-by-color basis, and to an image forming method.

2. Description of the Related Art

In a 4-series tandem type color digital multi-function peripheral (MFP), in the case where development is performed in an order of yellow (Y) magenta (M)→cyan (C)→black (K), it is necessary to output M/C/K color image data with delays corresponding to distances between drums, relative to Y color image data that is the first development color. In this case, respective-color image data are delayed by temporarily storing M/C/K color image data of in-phase Y/M/C/K image data in memories for delay (“delay memories”).

For example, when the distance between the drums for the respective colors is 80 mm, the resolution of image data is 600 dpi and the image data amount per pixel is 8 bits, it is necessary to delay M color image data, which is the second development color, by 80 (mm)/25.4 (mm)×600 dpi=1890 lines relative to the Y color image data that is the first development color, to delay C color image data, which is the third development color, by 3780 lines, and to delay K color image data, which is the fourth development color, by 5670 lines.

The number of pixels per line is 297 (mm)/25.4 (mm)×600 dpi=7016, since the longitudinal length is 297 mm in the case of an “A4” size. Thus, the capacity of the delay memory necessary for delaying the M color image data is 7016 (pixels)×8 bits×1890 (lines)=106 (M bits), the capacity of the delay memory necessary for delaying the C color image data is 212 (M bits), and the capacity of the delay memory necessary for delaying the K color image data is 318 (M bits).

In recent years, the image quality of color MFPs has steadily been enhanced, and enhancement of reproduction of fine parts is one of items to be achieved for higher image quality. In order to achieve this, it is effective to enhance the resolution. The enhancement in resolution means to increase a resolution of 600 dpi, for instance, to 1200 dpi or 2400 dpi. For example, if the resolution increases from 600 dpi to 1200 dpi, the number of pixels in a unit area increases. Hence, the reproduction of fine parts can be improved.

However, when the resolution is increased, the number of pixels increases and the data amount of image data increases accordingly. If the resolution is simply increased, the amount of image data to be delayed increases and accordingly the delay memory capacity increases. For example, in the case of 1200 dpi, the amount of image data simply increases four times as large as that in the case of 600 dpi. The necessary capacity of the delay memory also increases four times, and the memory cost would be doubled.

### BRIEF SUMMARY OF THE INVENTION

The object of an aspect of the present invention is to provide a color image forming apparatus that is capable of forming a color image with an enhanced resolution, while suppressing an increase in data amount, and an image forming method.

According to an aspect of the present invention, there is provided a 4-series tandem type color image forming apparatus comprising: a memory section that delays input image data; and a control section that executes, when the image data is input to the memory section, a control to vary a resolution and a number of bits per pixel of the input image data in accordance with a memory capacity of the memory section.

According to another aspect of the present invention, there is provided an image forming method for a 4-series tandem type color image forming apparatus, which forms an image by using a memory section that delays input image data, comprising: varying a data amount per pixel of input image data in accordance with a capacity of the memory section; packing a plurality of pixels, or dividing one pixel into a plurality of pixels, with respect to the image data, the data amount of which is varied; restoring the image data, which is packed or divided, to an original 1-pixel unit; and forming an image on the basis of the restored image data.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate preferred embodiments of the invention, and together with the general description given above and the detailed description of the embodiments given below, serve to explain the principles of an aspect of the invention.

FIG. 1 is a block diagram that schematically shows the structure of a color digital multi-function peripheral according to a color image forming apparatus of the present invention;

FIG. 2 is a conceptual view that shows the relationship between resolutions and pixels;

FIG. 3 shows an example of a setting screen of a printer driver in an input unit;

FIG. 4 shows an example in which four pixels are packed into a (2×2) unit;

FIG. 5 shows an example in which four pixels are packed into a (1×4) unit;

FIG. 6 shows other examples of packing of pixels in relation to resolutions;

FIG. 7 shows a relationship between the resolution and the number of image data bits per pixel; and

FIG. 8 is a view that schematically shows the structure of a color digital multi-function peripheral.

### DETAILED DESCRIPTION OF THE INVENTION

An embodiment of the present invention will now be described with reference to the accompanying drawings.

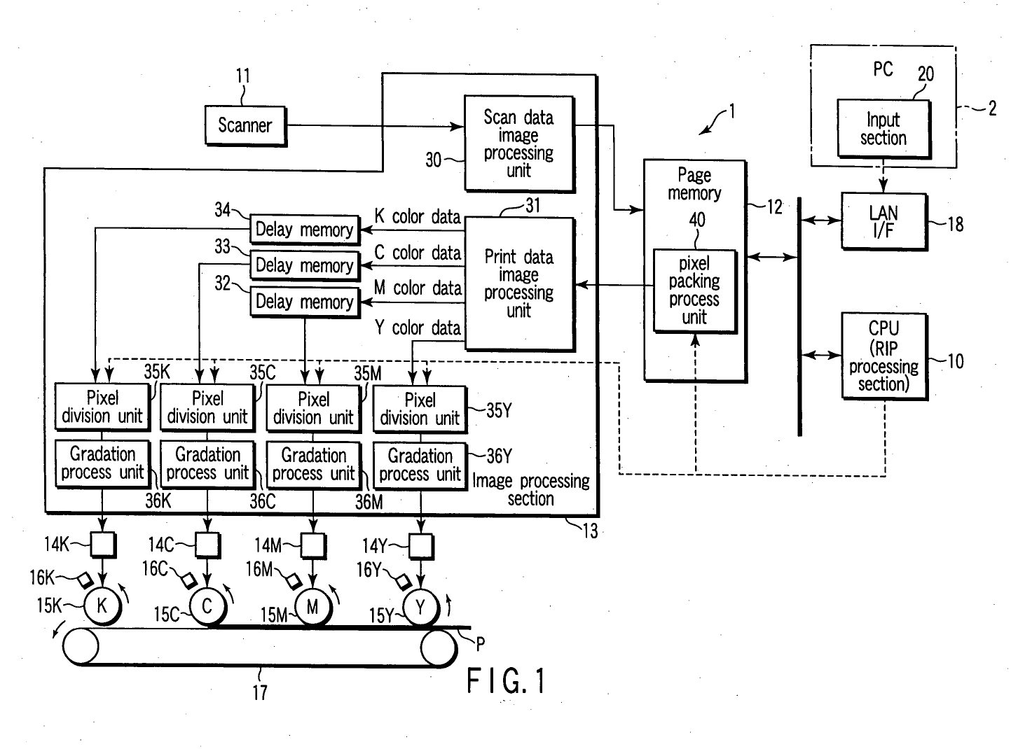

FIG. 1 schematically shows the structure of a color digital multi-function peripheral (MFP) according to a color image forming apparatus of the present invention.

The color MFP 1 comprises a CPU 10 that executes an overall control including a control of a RIP process section; a scanner 11; a page memory 12; an image processing section 13; laser emission sections 14Y, 14M, 14C and 14K; photoconductor drums 15Y, 15M, 15C and 15K; developing devices 16Y, 16M, 16C and 16K; a transfer belt 17; and a LAN interface (I/F) 18.

The page memory 12 includes a pixel packing process section 40, as will be described later in detail.

The image processing section 13 includes a scan data image process unit 30, a print data image process unit 31, delay memories 32, 33 and 34, pixel division units 35Y, 35M, 35C and 35K, and gradation process units 36Y, 36M, 36C and 36K.

A personal computer (PC) 2 is connected to the color MFP 1 via the LAN I/F 18. The PC 2 includes an input unit 20.

The outline of the present invention with the above-described structure is described.

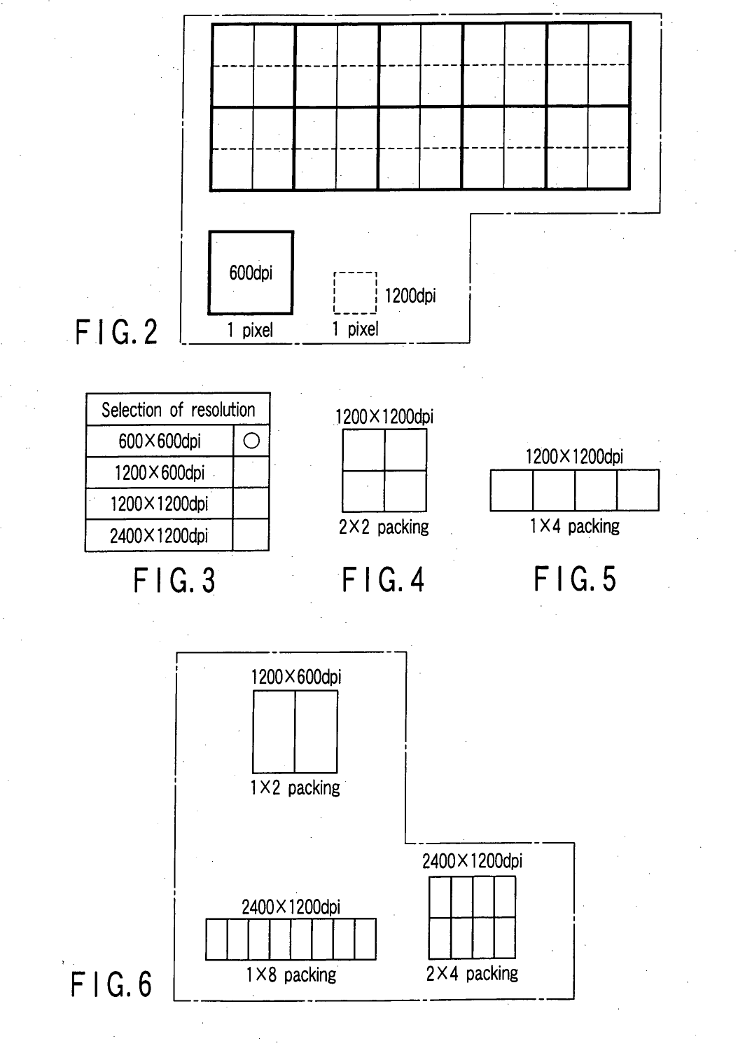

In order to realize fine-part reproduction, the enhancement in resolution is effective. The enhancement in resolution, in this context, means, for example, that a resolution of 600 dpi is enhanced to 1200 dpi or 2400 dpi. For example, when the resolution is increased from 600 dpi to 1200 dpi, as shown in FIG. 2, the number of pixels per unit area increases. Thus, the fine-part reproduction can be improved. However, when the resolution is enhanced as described above, the number of pixels increases and accordingly the data amount of image data increases.

In usual cases, when high-resolution printing is effected, reproduction of fine parts, such as fine characters, is considered important, but gradation is not considered important.

In the present invention, when high-resolution printing is effected, the data amount per pixel is decreased in order to prevent an increase in total image data amount. Further, image data of a plurality of pixels is packed. Thereby, a delay process for high-resolution image data is enabled with the same delay memory capacity as in the case of delaying 8-bit image data at a normal resolution of 600 dpi.

Next, the details of the color MFP 1 of the present invention are described.

The color MFP 1 normally processes image data with 8 bits at 600×600 dpi.

A description is given, for example, to a case where the color MFP 1 of the present invention is used as a network printer with a high resolution of 1200×1200 dpi.

To start with, the user explicitly selects printing at 1200×1200 dpi through a setting screen of the printer driver of the input unit 20 of the PC 2.

FIG. 3 shows an example of the setting screen of the printer driver in the input unit 20. Specifically, “600×600 dpi”, “1200×600 dpi”, “1200×1200 dpi” and “2400×1200 dpi” are displayed as choices of resolution.

If the CPU 10 is informed that “1200×1200 dpi” has been selected from the input unit 20, the CPU 10 switches a normal 8-bit RIP process with 600×600 dpi to a 1-bit RIP process with 1200×1200 dpi. That is, the CPU 10 executes the RIP process so that image data may become 1-bit data with 1200 dpi.

Image data, which has become 1-bit data with 1200 dpi, is once stored in the page memory 12.

The pixel packing process unit 40 executes (2×2) packing when the image data stored in the page memory 12 is to be output from the page memory 12.

By packing four pixels as shown in FIG. 4, the delay memories 32, 33 and 34 can be made common to a normal case of handling 8-bit image data.

Alternatively, it is possible to execute (1×4) packing, as shown in FIG. 5. In this case, the number of lines is doubled, compared to the case of 600 dpi, and attention has to be paid to the control of the delay memories 32, 33 and 34. However, the memory capacity can be made common to the case of 600 dpi.

The packed Y color image data is restored, without delay, to a normal pixel unit in the pixel division unit 35Y, subjected to a gradation process in the gradation process unit 36Y, and output to the laser emission section 14Y. A laser beam from the laser emission section 14Y is applied to the photoconductor drum 15Y, and development is executed by the developing device 16Y. A resultant Y color developer image is transferred to paper P on the transfer belt 17.

The packed M color image data is restored, with a delay in the delay memory 32, to a normal pixel unit in the pixel division unit 35M, subjected to a gradation process in the gradation process unit 36M, and output to the laser emission section 14M. A laser beam from the laser emission section 14M is applied to the photoconductor drum 15M, and development is executed by the developing device 16M. A resultant M color developer image is transferred to the paper P on the transfer belt 17.

The packed C color image data is restored, with a delay in the delay memory 33, to a normal pixel unit in the pixel division unit 35C, subjected to a gradation process in the gradation process unit 36C, and output to the laser emission section 14C. A laser beam from the laser emission section 14C is applied to the photoconductor drum 15C, and development is executed by the developing device 16C. A resultant C color developer image is transferred to the paper P on the transfer belt 17.

The packed K color image data is restored, with a delay in the delay memory 34, to a normal pixel unit in the pixel division unit 35K, subjected to a gradation process in the gradation process unit 36K, and output to the laser emission section 14K. A laser beam from the laser emission section 14K is applied to the photoconductor drum 15K, and development is executed by the developing device 16K. A resultant K color developer image is transferred to the paper P on the transfer belt 17.

If a problem arises with the image quality relating to gradation due to the conversion to 1-bit data, the image data is delayed by the delay memories (32, 33, 34), and then pattern matching is performed with reference to neighboring areas of a pixel of interest, thereby executing a gradation process for converting 1-pixel image data from 1-bit data to 8-bit data. Thus, the problem with the image quality can be solved.

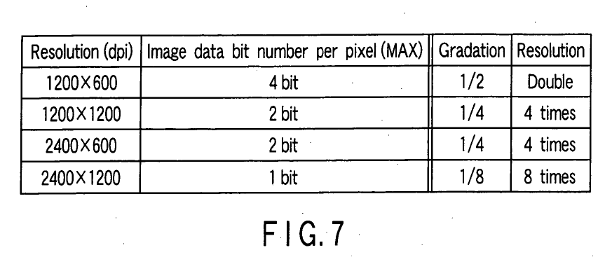

The resolution is not limited to 1200 dpi, and may be 1200×600 dpi, 2400×1200 dpi, etc., as shown in FIG. 6. By decreasing the number of bits of image data per pixel and executing packing, the delay memory capacity can be made common to the case of 600 dpi.

FIG. 7 shows the relationship between the resolution in this case and the number of image data bits per pixel. A reference value of the resolution is set at 600×600 dpi with a bit number of 8 bits. If the resolution is set at 1200×600 dpi, the number of image data bits per pixel is 4 bits. As a result, the gradation becomes ½ and the resolution is doubled.

If the resolution is set at 1200×1200 dpi, the number of image data bits per pixel is 2 bits. As a result, the gradation becomes ¼ and the resolution increases four times.

If the resolution is set at 2400×600 dpi, the number of image data bits per pixel is 2 bits. As a result, the gradation becomes ¼ and the resolution increases four times.

If the resolution is set at 2400×1200 dpi, the number of image data bits per pixel is 1 bit. As a result, the gradation becomes ⅛ and the resolution increases eight times.

The above-described embodiment relates to a network printing mode. Next, a description is given of the structure wherein a conversion unit for data is provided in the image processing section that processes image data from the scanner section.

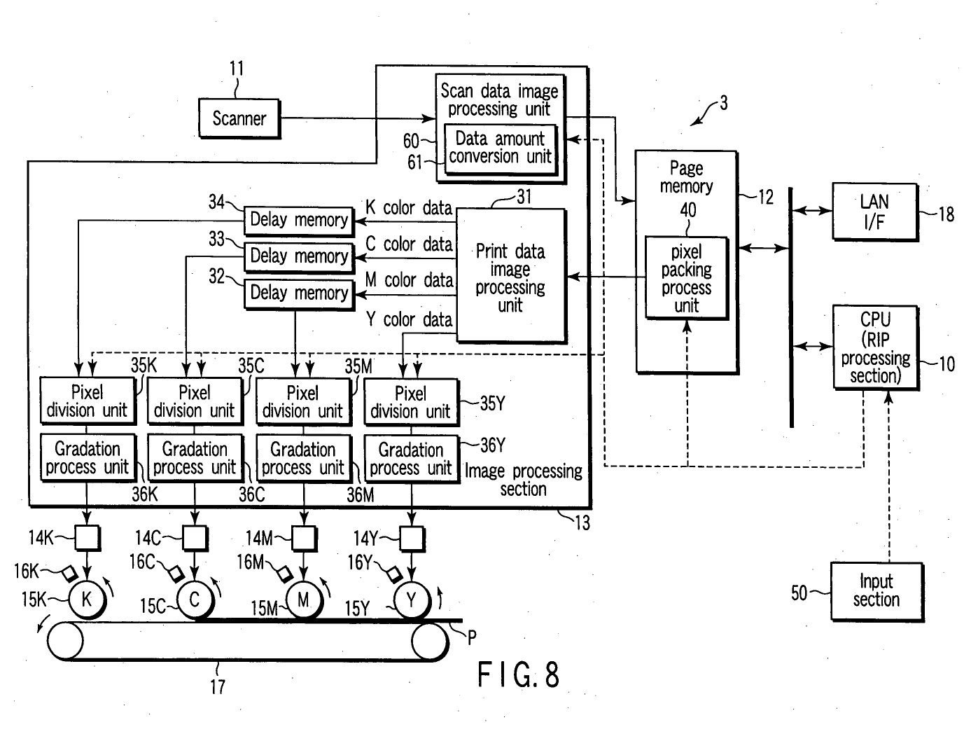

FIG. 8 schematically shows the structure of a color digital multi-function peripheral (MFP) 3. The parts common to those of the MFP 1 shown in FIG. 1 are denoted by like reference numerals, and a description is omitted. The difference is that an input section 50 of the present apparatus is connected to the CPU 10, and a scan data image processing unit 60 includes a data amount conversion unit 61.

Specifically, the data amount conversion unit 61 converts 8-bit image data with 600 dpi to lower-bit-number image data with a higher resolution. Thereby, even when copying is executed, the delay memory capacity does not need to be increased and an output with a high resolution is enabled.

The above-described embodiment is directed to the case of high resolution and a low bit number. In the present invention, there is a case where a low resolution/high gradation image quality is desired. In this case, it is similarly possible to lower the resolution and to increase the data amount per pixel.

For example, in the case where the resolution is lowered to 300 dpi, the data amount per pixel may be set at 32 bits. Thereby, an image quality with good gradation characteristics can be realized. In this case, one pixel is divided into two pixels in the pixel packing process unit 40, and the divided pixels are output from the delay memories (32, 33, 34). The pixel division units (35Y, 35M, 35C, 35K) restore the pixels to a 1-pixel unit. Thereby, the delaying process for high-gradation image data can be executed with the same delay memory capacity as in the case of 8-bit data with 600 dpi.

As has been described above, according to the embodiment of the present invention, in the color MFP that normally handles 8-bit image data with 600 dpi, the image data amount per pixel is reduced when high-resolution image data is to be handled. Further, a plurality of pixels are packed. Thus, the delay memories can be used without increasing the memory capacity.

Besides, if a problem with the image quality arises due to the decrease in image data amount, the gradation process for solving the problem is executed. Thereby, the problem with the image quality can be solved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A 4-series tandem type color image forming apparatus comprising:
a memory section that delays input image data; and
a control section that executes, when the image data is input to the memory section, a control to vary a resolution and a number of bits per pixel of the input image data in accordance with a memory capacity of the memory section.

2. A 4-series tandem type color image forming apparatus comprising:
a first image data processing section that varies a data amount per pixel of input image data;
a second image data processing section that packs a plurality of pixels, or divides one pixel into a plurality of pixels, with respect to the image data, the data amount of which is varied by the first image data processing section;
a third image data processing section that restores the image data, which is packed or divided by the second image data processing section, to an original 1-pixel unit; and
a control section that switches processes in the first, second and third image processing sections.

3. The color image forming apparatus according to claim 2, wherein the control section executes, when high-resolution image data is handled, a control to effect switching to a process of decreasing the data amount in the first image data processing section, a process of packing a plurality of pixels of the image data in the second image data processing section, and a process of dividing the image data packed by the third image data processing section into a 1-pixel unit.

4. The color image forming apparatus according to claim 2, wherein the control section executes, when low-resolution image data is handled, a control to effect switching to a process of increasing the data amount in the first image data processing section, a process of dividing one pixel into a plurality of pixels in the second image data processing section, and a process of restoring the image data divided by the third image data processing section to a 1-pixel unit.

5. The color image forming apparatus according to claim 2, further comprising a gradation processing section at a rear stage of the third image data processing section, which executes a gradation process to convert low-gradation image data to high-gradation image data.

6. An image forming method for a 4-series tandem type color image forming apparatus, which forms an image by using a memory section that delays input image data, comprising:
varying a data amount per pixel of input image data in accordance with a capacity of the memory section;
packing a plurality of pixels, or dividing one pixel into a plurality of pixels, with respect to the image data, the data amount of which is varied;
restoring the image data, which is packed or divided, to an original 1-pixel unit; and
forming an image on the basis of the restored image data.
